(19) United States
(12) Patent Application Publication
(10) Pub. No.: US 2025/0154294 A1
(43) Pub. Date: May 15, 2025

(54) METHOD OF PREPARING EPDM COPOLYMER

(71) Applicants: SK INNOVATION CO., LTD., Seoul (KR); SK GEO CENTRIC CO., LTD., Seoul (KR)

(72) Inventors: Byoung Tak YIM, Daejeon (KR); Jeong Hwan KIM, Daejeon (KR)

(21) Appl. No.: 18/653,986

(22) Filed: May 3, 2024

(30) Foreign Application Priority Data
Nov. 9, 2023 (KR) 10-2023-0154196

(51) Int. Cl. C08F 4/20; C08F 2/06; C08F 4/14; C08F 210/16

(52) U.S. Cl. CPC C08F 4/20; C08F 2/06; C08F 4/14; C08F 210/16; C08F 2410/00

(57) ABSTRACT

A method of preparing an EPDM copolymer by solution polymerization using a Ziegler-Natta catalyst system, in which the Ziegler-Natta catalyst system includes VOCl₃, ethylaluminum sesquichloride (EASC), and a straight chain or branched chain C4-C6 alkyl amine as a catalyst modifier. The method includes performing polymerization by adding the catalyst modifier before injecting VOCl₃ or by adding VOCl₃ and the catalyst modifier simultaneously.

### CROSS-REFERENCE TO RELATED APPLICATIONS

This application claims priority under 35 U.S.C. § 119 to Korean Patent Application No. 10-2023-0154196, filed on Nov. 9, 2023, in the Korean Intellectual Property Office, the disclosure of which is incorporated herein by reference in its entirety.

### TECHNICAL FIELD

The present disclosure relates to a method of preparing an EPDM copolymer. More particularly, the present disclosure relates to a method of preparing an ethylene propylene diene (EPDM) copolymer by solution polymerization using a Ziegler-Natta catalyst system, which is a method of preparing an EPDM copolymer having a narrow molecular weight distribution.

### BACKGROUND

An EPDM copolymer is a polymer prepared from ethylene, propylene, and diene comonomers, and as the diene, ethylidene norbornene (ENB), dicyclopentadiene (DCPD), vinyl norbornene (VNB), and the like are often used.

In general, an EPDM copolymer is a vulcanizable copolymer and shows physical properties such as excellent weather resistance, heat resistance, and ozone resistance, and thus, is variously used in various rubber products, for example, automobile components, industrial rubber products, electrical insulation materials, civil engineering materials, construction materials, and the like.

### SUMMARY

In one general aspect, a method of preparing an ethylene propylene diene (EPDM) copolymer by solution polymerization using a Ziegler-Natta catalyst system, wherein the Ziegler-Natta catalyst system includes VOCl₃, ethylaluminum sesquichloride (EASC), and a straight chain or branched chain C4-C6 alkyl amine as a catalyst modifier, and the method includes: performing polymerization by adding the catalyst modifier before injecting VOCl₃ or by adding VOCl₃ and the catalyst modifier simultaneously.

In another embodiment, the EPDM copolymer may have a molecular weight distribution (Mw/Mn) of 5 or less, 2 to 5, 2 to 4.5, 2 to 4 or 2 to 3 (where Mw is a weight average molecular weight and Mn is a number average molecular weight). The number average molecular mass is the ordinary arithmetic mean or average of the molecular masses of the individual macromolecules in the copolymer. The weight average molecular weight is calculated by a) summing (for each mass) the product of the number of the individual macromolecules at a particular mass by that mass squared and b) dividing this product by the product of the sum of the number of the individual macromolecules at a particular mass and that mass. In another embodiment, the EPDM copolymer may have a residual vanadium content of 30 ppm or less, 20 ppm or less, but the present invention is not limited thereto. For example, the EPDM copolymer may have a residual vanadium content of 1 to 30 ppm, 1 to 20 ppm, but the present invention is not limited thereto.

In another embodiment, the EPDM copolymer may have a weight average molecular weight ranging from 200,000 to 400,000 g/mol, 210,000 to 390,000 g/mol, 220,000 to 390,000 g/mol, 230,000 to 390,000 g/mol, but the present invention is not limited thereto.

In another embodiment, a content of the catalyst modifier may be a mole ratio ranging from 0.25 to 1 with respect to 1 mol of VOCl₃, but the present invention is not limited thereto.

In another embodiment, a content of the catalyst modifier may be a mole ratio ranging from 0.25 to 1 with respect to 1 mol of VOCl₃, a content of the catalyst modifier may be a mole ratio ranging from 0.5 to 1 with respect to 1 mol of VOCl₃, a content of the catalyst modifier may be a mole ratio ranging from 0.75 to 1 with respect to 1 mol of VOCl₃, but the present invention is not limited thereto.

In another embodiment, the catalyst modifier may be n-butylamine, but the present invention is not limited thereto.

In another embodiment, the preparation method may be a batch or continuous polymerization method.

In another embodiment, a solvent used in a reaction during the solution polymerization may be a hydrocarbon-based solvent, but is not limited thereto. For example, the hydrocarbon-based solvent may be any one or a mixture of two or more selected from the group consisting of pentane, hexane, heptane, octane, and the like, but the present invention is not limited thereto.

In another embodiment, the polymerization step may be performed at 30 to 50° C., but the present invention is not limited thereto.

In another embodiment, in the polymerization step, a content ratio of propylene, ethylene, and 5-ethylidene-2-norbornene (ENB) may range from 20 to 40 wt % of propylene, 50 to 70 wt % of ethylene, and 5 to 10 wt % of 5-ethylidene-2-norbornene (ENB), but the present invention is not limited thereto.

In another general aspect, an EPDN copolymer prepared by the preparation method according to this embodiment is provided.

In still another general aspect, a compound composition includes the EPDM copolymer prepared by the preparation method according to this embodiment.

In another embodiment, the compound composition may have a compression set of 50% or less, when the composition is maintained compressed by 25% for 22 hours at a temperature of 120° C. in accordance with ASTM D-395.

In another embodiment, a polymer comprising:
propylene,
ethylene, and
5-ethylidene-2-norbornene (ENB),
wherein a content ratio of the propylene, the ethylene, and the ENB ranges from 20 to 40 wt % of the propylene, 50 to 70 wt % of the ethylene, and 5 to 10 wt % of the ENB.

In another embodiment, the polymer having a molecular weight distribution of Mw/Mn, where Mw is weight average molecular weight and Mn is the number average molecular weight, ranges from 2 to 5.

In another embodiment, the polymer having a residual vanadium content ranging from 1 to 30 ppm.

In another embodiment, the polymer having a weight average molecular weight ranging from 200,000 to 400,000 g/mol.

In another embodiment, the polymer having a compression set of ranging from 40 to 50% in accordance with ASTM D-395. Other features and aspects will be apparent from the following detailed description, the drawings, and the claims.

### BRIEF DESCRIPTION OF THE DRAWINGS

FIG. 1 shows GPC differential molecular weight distribution curves of EPDM polymers (Examples 1 to 3) produced in EPDM polymerization by previously mixing a catalyst modifier (n-BA) and a catalyst and adding the mixture and the comparative example.

FIG. 2 shows GPC differential molecular weight distribution curves of EPDM polymers (Examples 4 to 6) produced in polymerization by adding a catalyst modifier (n-BA) and a catalyst to a reactor without previously mixing and the comparative example.

### DETAILED DESCRIPTION OF EMBODIMENTS

Hereinafter, the present disclosure will be described in more detail. However, the following specific examples or disclosed embodiments are only a reference for describing the present invention in detail, and the present invention is not limited thereto, and may be implemented in various forms.

In addition, unless otherwise defined, all technical terms and scientific terms have the same meanings as those commonly understood by those skilled in the art to which the present disclosure pertains. The terms used herein are for describing specific examples, and are not intended to limit the present disclosure.

In addition, the singular form used in the specification and claims appended thereto may be intended to include a plural form also, unless otherwise indicated in the context.

In addition, unless particularly described to the contrary, “comprising” any elements will be understood to imply further inclusion of other elements rather than the exclusion of any other elements.

In addition, when unique manufacture and material allowable errors are suggested in the mentioned meaning, the terms “about”, “substantially”, and the like used in the present disclosure, and the like are used in the meaning of the numerical value or in meaning close to the numerical value.

In order to apply a copolymer to a weather strip and to make a seal between the copolymer and different automobile components, low compression set properties at room temperature and at high temperature are desirable. (Compression set is an assessment of the extent to which a material is restored from a state compressed by external pressure over time.) To this end, a recipe for a compound composition can be adjusted and used, in consideration that the resultant compression set is substantially affected by a molecular structure in the copolymer, that is, a molecular weight distribution of the EPDM copolymer in a raw form. In order to lower the compression set, the molecular weight distribution of an EPDM copolymer should be narrowed.

Usually, when a solution polymerization is performed using for example a Ziegler-Natta catalyst system, a coupling reaction between 5-ethylidene-2-norbornene (ENB) may occur, which may produce a polymer having an ultra-high molecular weight for its weight average molecular weight. Though being not limited thereto, the ultra-high molecular weight as used herein refers to a weight average molecular weight of 1,000,000 g/mol or more (based on polystyrene in a gel permeation chromatography (GPC) analysis).

When a polymer having a ultra-high molecular weight is compounded, compression set properties may not be adequate, and the surface roughness of the compounded product may increase.

Therefore, an EPDM copolymer having a lowered ultra-high molecular weight and a narrow molecular weight distribution is desired.

One embodiment of the present invention is directed to providing an EPDM copolymer which has a narrow molecular weight distribution by controlling a reaction of making ultra-high molecular weight in a polymerization process of EPDM and may lower a compression set in the resulting compound composition, and a method of preparing the same.

Another embodiment of the present invention is directed to providing an EPDM copolymer which may provide a low compression set, specifically a low compression set after being maintained at 70° C. for 72 hours in accordance with ASTM D-395, and a method of preparing the same. For example, the compression set of ranging from 40 to 508, 41 to 50%, 42 to 50%, 43 to 50%, 44 to 50%, 45 to 50%, 45.3 to 50% in accordance with ASTM D-395.

In another embodiment of the present disclosure, as a result of the inventors studying how to narrow the molecular weight distribution of EPDM, it was found that a narrower molecular weight distribution may be provided by controlling a reaction of making a ultra-high molecular weight, and also, an EPDM copolymer having a lower molecular weight content can be provided with the same molecular weight distribution as in the ultra-high molecular weight copolymer.

Usually, when EPDM is prepared by solution polymerization with a Ziegler-Natta catalyst, a cation is produced in 5-ethylidene-2-norbornene (ENB) between EPDM molecules due to acid catalyst and cocatalyst, and a reaction with another ENB molecule proceeds, thereby producing a macromolecule. That is, an EPDM coupling reaction proceeds in a polymerization system by an ENB coupling reaction to produce an ultra-high molecular weight tail.

In one embodiment of the present disclosure, in order to prevent a reaction of an ENB cation with ENB of another molecule, a catalyst system of a specific combination has been developed which prevents or reduces formation of the macromolecule. A method of producing an EPDM copolymer was realized in which an order of addition of the components and catalyst is specified using the catalyst system of the present disclosure, thereby providing an EPDM copolymer which has a narrow molecular weight distribution and a lower ultra-high molecular weight content.

The present inventors studied (in order to control a reaction of making a polymer have an ultra-high molecular weight during an EPDM polymerization reaction) how to prepare an EPDM copolymer having a narrow molecular weight distribution. As a result, the inventors found that the above object may be achieved by preparing the EPDM copolymer by solution polymerization using a reaction system of a specific combination based on a Ziegler-Natta catalyst as described below.

In addition, the inventors found that when solution polymerization is performed using the Ziegler-Natta catalyst system of the specific combination, an order of addition (as described below) of a catalyst and a catalyst modifier is specified.

In addition, the inventors found that when a specific molecular weight distribution (Mw/Mn) (where Mw is a weight average molecular weight and Mn is a number average molecular weight) is satisfied, an effect of further improving a compression set during preparation of a compound composition may be achieved.

One embodiment of the present disclosure provides a method of preparing an EPDM copolymer by solution polymerization using a Ziegler-Natta catalyst system, wherein the Ziegler-Natta catalyst system includes VOCl₃, ethylaluminum sesquichloride (EASC), and a straight chain or branched chain C4-C6 alkyl amine as a catalyst modifier, and the method includes: performing polymerization by adding the catalyst modifier before injecting VOCl₃ or by adding VOCl₃ and the catalyst modifier simultaneously.

The adding of VOCl₃ and a catalyst modifier simultaneously includes a) separately adding to each inlet or b) adding as a mixture by previously mixing VOCl₃ and the catalyst modifier.

The EPDM copolymer prepared according to one embodiment may have a molecular weight distribution (Mw/Mn) of 5 or less, 4 or less, or 3 or less. When the compound composition for being applied to an automotive weather strip, seal, or the like is prepared in a range of the molecular weight distribution of 3 or less, for example, 2 to 3 without limitation, the compression set may be further lowered, which is optional. For example, the physical properties of a compression set of 50% or less, 49% or less, 48% or less, or 47% or less after maintaining it compressed by 25% for 22 hours at a temperature of 120° C. in accordance with ASTM D-395 may be satisfied.

In addition, a residual vanadium content may be 30 ppm or less, 25 ppm or less, 20 ppm or less, 19 ppm or less, 18 ppm or less, 17 ppm or less, 16 ppm or less, 15 ppm or less, 14 ppm or less, 13 ppm or less, 12 ppm or less, 11 ppm or less, 10 ppm or less, 9 ppm or less, 8 ppm or less, 7 ppm or less, or an arbitrary value between the numerical values. When the residual vanadium content of the polymer prepared by the preparation method is more than 30 ppm, a yellowing phenomenon in which the color of a product changes may occur, and it may be difficult to achieve a low compression set when preparing the compound composition. For example, the residual vanadium content may range from 1 to 30 ppm, 1 to 25 ppm, 1 to 20 ppm, 1 to 17 ppm, 1 to 16 ppm, 1 to 15 ppm, 1 to 14 ppm, 1 to 13 ppm, 1 to 12 ppm, 1 to 11 ppm, 1 to 10 ppm, 1 to 9 ppm, 1 to 8 ppm, or 1 to 7 ppm.

The present disclosure in one embodiment may provide an EPDM copolymer having a molecular weight distribution (Mw/Mn) of 5 or less or 3 or less and a residual vanadium content of 30 ppm or less by using a combination of specific components with a Ziegler-Natta catalyst system, as described above. In addition, the EPDM copolymer prepared according to another embodiment may include an ultra-high molecular weight polymer, which has a weight average molecular weight measured according to a Gel permeation chromatography (GPC) method of 1,000,000 or more, in a range of 1% or less.

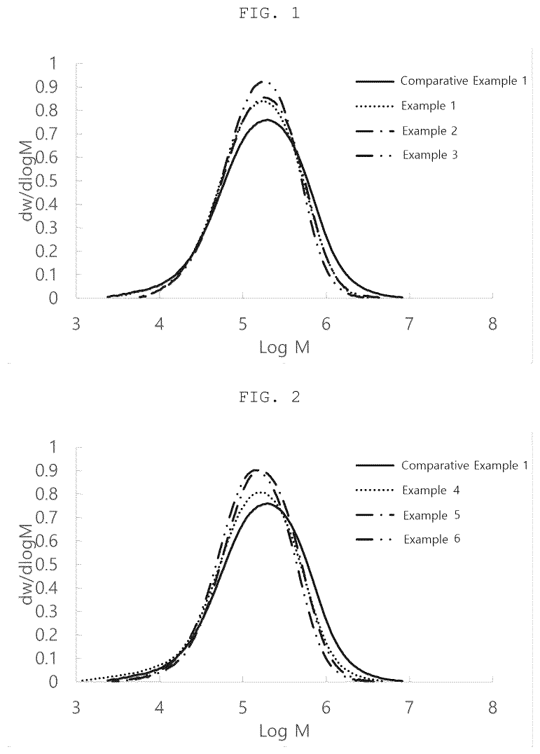

In one embodiment, as shown in FIGS. 1 and 2, as compared with an EPDM polymer which is polymerized without using the catalyst modifier or by using the Ziegler-Natta catalyst system using a compound other than the straight chain or branched chain C4-C6 alkyl amine, an EPDM copolymer which shows a r narrower range in the same weight average molecular weight may be provided.

In another embodiment, as shown in FIGS. 1 and 2, an EPDM copolymer which shows a relatively lower dw/dlog (M) value in an ultra-high molecular weight range of log (M) of 6 to 7, in a differential molecular weight distribution curve in which the horizontal axis is a logarithmic value of molecular weight M, log (M), and the vertical axis is dw/dlog (M) obtained by differentiating a concentration fraction w by the logarithmic value of molecular weight, log (M), may be provided.

Next, a method of preparing an EPDM copolymer of the present disclosure will be described in more detail.

The preparation method according to one embodiment of the present disclosure may be performed by a batch or continuous polymerization method.

In this embodiment, the batch preparation method may include:
a) a preparation step of adding a hydrocarbon-based solvent, ethylaluminum sesquichloride (EASC), propylene, ethylene, and 5-ethylidene-2-norbornene (ENB) to a reactor and performing stirring; and
b) a polymerization step of adding VOCl₃ and a straight chain or branched chain C4-C6 alkyl amine as a catalyst modifier to the reactor, in which the reaction is performed by adding the catalyst modifier before injecting VOCl₃ or adding VOCl₃ and the catalyst modifier simultaneously to the reactor.

In the batch polymerization method, for removing impurities in the solvent, ethylaluminum sesquichloride (EASC) may be first added, and then VOCl₃ and the catalyst modifier may be added, but the present disclosure is not limited thereto.

Therefore, this method may include: a) a preparation step of adding a hydrocarbon-based solvent, propylene, ethylene, and 5-ethylidene-2-norbornene (ENB) to a reactor and performing stirring; and

b) a polymerization step of adding ethylaluminum sesquichloride (EASC), VOCl₃, and a straight chain or branched chain C4-C6 alkyl amine as a catalyst modifier to the reactor, in which the reaction is performed by adding the catalyst modifier before injecting VOCl₃ or adding VOCl₃ and the catalyst modifier simultaneously to the reactor.

In another embodiment, the continuous polymerization method may include a polymerization step of continuously adding a hydrocarbon-based solvent, propylene, ethylene, and 5-ethylidene-2-norbornene (ENB) to a reactor, and adding ethylaluminum sesquichloride (EASC) and VOCl₃ as a catalyst and a straight chain or branched chain C4-C6 alkyl amine as a catalyst modifier, in which the reaction is performed by adding the catalyst modifier before injecting VOCl₃ or adding each of VOCl₃ and the catalyst modifier to the reactor.

In another embodiment, the polymerization step may be performed at 30 to 50° C. More specifically, a process of adding a hydrocarbon-based solvent, propylene, ethylene, and 5-ethylidene-2-norbornene (ENB) to a reactor may be performed at 30 to 35° C., and in the process of adding a Ziegler-Natta catalyst system of the present disclosure, an initial temperature may be 30 to 35° C. and polymerization may be performed at 35 to 50° C. after adding the Ziegler-Natta catalyst system. The range is preferred since a side reaction and yellowing of the produced polymer may be decreased, but is not limited thereto.

In another embodiment, the reaction may be performed by adding the catalyst modifier before adding VOCl₃ or adding VOCl₃ and the catalyst modifier simultaneously to the reactor, when the catalyst is added. Though being not limited thereto, the reaction may be performed in the same order of addition as described above, thereby preparing the EPDM copolymer having desirable physical properties.

In another embodiment, the hydrocarbon-based solvent may be any one or two or more solvents selected from the group consisting of pentane, hexane, heptane, octane, and the like. In addition, the hydrocarbon-based solvent may include a solvent which is used after being recovered after the polymerization step, purified, and recirculated, but the present invention is not limited thereto.

In another embodiment, the Ziegler-Natta catalyst system includes a cocatalyst for improving the catalyst efficiency of VOCl₃, and includes ethylaluminum sesquichloride (EASC) as the cocatalyst. In addition, if necessary, other types of cocatalyst may be further used in addition to the ethylaluminum sesquichloride (EASC).

Specifically, for example, trialkylaluminum such as trimethylaluminum, triethylaluminum, triisopropylaluminum, triisobutylaluminum, trioctylaluminum, and tri-2-ethylhexylaluminum; alkenylaluminum such as isoprenylaluminum; dialkylaluminum halide such as dimethylaluminum chloride, diethylaluminum chloride, diisopropylaluminum chloride, diisobutylaluminum chloride, and dimethylaluminum bromide; alkylaluminum sesquihalide such as methylaluminum sesquichloride, isopropylaluminum sesquichloride, butylaluminum sesquichloride, and ethylaluminum sesquibromide; alkylaluminum dihalide such as methylaluminum dichloride, ethylaluminum dichloride, isopropylaluminum dichloride, and ethylaluminum dibromide; alkylaluminum hydride such as diethylaluminumhydride and diisobutylaluminumhydride, and the like may be used.

When the polymerization is performed by including a vanadium catalyst and an acid ethylaluminum sesquichloride (EASC) cocatalyst as such, the reaction conditions are acidic, and thus, a coupling reaction between 5-ethylidene-2-norbornene (ENB) may be derived in the polymerization step. Accordingly, ultra-high molecular weight is increased to increase a compression set in compounding.

In one embodiment in the present disclosure, the polymerization is performed by adding straight chain or branched chain C4-C6 alkyl amine as a catalyst modifier to the catalyst system, thereby suppressing the coupling reaction.

In another embodiment, the straight chain or branched chain C4-C6 alkyl amine as the catalyst modifier may be a primary amine, a secondary amine, and a tertiary amine. The type may be, for example, n-butyl amine, di-butyl amine, t-butyl amine, pentylamine, hexylamine, and the like. In the case of the alkyl group having less than 4 carbons or in the case of ammonia, its boiling point is low and it has low solubility in the hydrocarbon-based solvent as the reaction solvent, it is separated as a gas phase in the upper stage of the reactor and hardly exists in a liquid phase in the lower stage of the reactor where EPDM is actually polymerized, and thus, has low reaction participation efficiency in the reaction of suppressing ultra-high molecular weight production to be intended. In addition, in the case of the alkyl group having more than 6 carbons, an effect of suppressing ultra-high molecular weight may be maintained, but the catalyst is not removed after the polymerization reaction and the catalyst finally remains in the product to cause a serious side reaction which leads to discoloration, and thus, there may be a limitation in application to the product. In addition, an excessive amount of residual catalyst accelerates an EPDM decomposition reaction to cause deterioration of physical properties. The catalyst modifier may be n-butylamine without limitation, and n-butylamine is preferred, since a better effect may be expressed with its use as compared with other alkyl amine, but the present disclosure is not limited thereto.

In one embodiment of the present disclosure, the straight chain or branched chain C4-C6 alkyl amine is used in situ, thereby suppressing the coupling reaction between 5-ethylidene-2-norbornene (ENB) occurring in polymerization under acidic conditions due to the catalyst combination of VOCl₃ and ethylaluminum sesquichloride (EASC) to suppress production of ultra-high molecular weight. In addition, an EPDM copolymer having a narrow molecular weight distribution, specifically, a molecular weight distribution of 5 or less or 3 or less may be provided, and an EPDM copolymer which has a low vanadium content remaining after polymerization and does not discolor may be provided.

In another embodiment, the content of the catalyst modifier may be a mole ratio of 0.25 to 1 or 0.5 to 1 with respect to VOCl₃. When the catalyst modifier is used at a mole ratio of 0.5 to 1, a polymer having a lower molecular weight distribution may be prepared, and for example, a polymer having a molecular weight distribution of 3 or less or 2 to 3 may be prepared. In addition, it may be advantageous for preparing an EPDM copolymer having a residual vanadium content of 20 ppm or less. When the content of the catalyst modifier is used at a mole ratio of more than 1, a catalytic poison action becomes severe to rather decrease catalytic activity.

In another embodiment, a mole ratio of vanadium of VOCl₃ to aluminum of ethylaluminum sesquichloride (EASC), Al/V, may be a mole ratio of 3 to 8. Though being not limited thereto, within the range, catalytic activity is better to further improve a polymerization yield, and an EPDM copolymer having a molecular weight distribution (Mw/Mn) of 3 or less and a residual vanadium content of 20 ppm or less may be prepared.

In another embodiment, a content ratio of propylene, ethylene, and 5-ethylidene-2-norbornene (ENB) may be 20 to 40 wt % of propylene, 50 to 70 wt % of ethylene, and 5 to 10 wt % of 5-ethylidene-2-norbornene (ENB), and is not limited thereto, but physical properties required for manufacturing an automotive weather strip may be provided within the range.

In another embodiment, the EPDM copolymer may have a weight average molecular weight ranging from 200,000 to 400,000 g/mol, and the range is desirable since the physical properties required for manufacturing an automotive weather strip may be provided, but the present invention is not limited thereto.

In another embodiment, the EPDM copolymer prepared according to one embodiment of the preparation method of the present disclosure has a decreased content of an ultra-high molecular weight polymer having a weight average molecular weight of 1,000,000 g/mol or more, as compared with an EPDM copolymer having the same molecular weight distribution. Specifically, referring to FIGS. 1 and 2, the graph of Examples 1 to 6 shows a lower molecular weight than Comparative Example 1 at about 6 showing a molecular weight of 1,000,000 g/mol in the horizontal axis which is a logarithmic value log (M) of molecular weight M. Accordingly, a polymer having a narrow molecular weight distribution and a lower ultra-high molecular weight content may be provided.

In another embodiment, the compound composition using the EPDM copolymer prepared according to one embodiment of the preparation method of the present disclosure may satisfy the physical properties of a compression set of 50% or less after being maintained compressed by 25% for 22 hours at a temperature of 120° C. in accordance with ASTM D-395.

In addition, the compound composition using the EPDM copolymer prepared according to one embodiment of the preparation method of the present disclosure may have lower a compression set, as compared with the compound composition using an EPDM copolymer prepared with different types of vanadium catalyst or without using the catalyst modifier of the present disclosure.

As an example, the compound composition may be a mixture of the EPDM copolymer prepared according to one embodiment of the preparation method of the present disclosure, carbon black, an additive, and the like.

Hereinafter, the present disclosure will be described in more detail with reference to the examples and the comparative examples. However, the following examples and comparative examples are only an example for describing the present disclosure in more detail, and do not limit the present disclosure.

Hereinafter, the physical properties were measured as follows:

1. Methods of measuring weight average molecular weight (Mw), z-average molecular weight (Mz), molecular weight distribution MWD, which is Mw/Mn, and ultra-high molecular weight.

These values were measured using gel permeation chromatography.

Gel permeation chromatography (GPC) used a product name 1260 INFINITY II available from Agilent.
Column: Graphite column
Solvent: TCB (trichlorobenzene)
Flow velocity: 1.0 ml/min
Sample concentration: 1.0 mg/ml
Injection amount: 200 μl
Column temperature: 160° C.
Detector: IR5 detector
Standard: Polystyrene (corrected with a cubic function)

### 2. Method of Measuring Residual Vanadium Content

0.1 g of a sample was added to a platinum crucible, sulfuric acid was added, and heating was performed to perform carbonization. When carbonization was completed, the temperature was cooled to room temperature, and incineration was performed in two steps at 250° C. and 600° C. in an electric furnace. When incineration was completed, the temperature was cooled to room temperature, and heating was performed with addition of nitric acid to dissolve residues. When dissolution was completed, heating was stopped and the product was diluted with 10 mL of ultrapure water. When a sample solution was introduced to an inductively coupled plasma (ICP) analyzer, metal components were ionized by plasma at about 6000 K, the ionized element was separated according to a mass to charge ratio (m/z) to obtain a mass spectrum, and each vanadium element was qualified and quantified from the intensity of the spectrum.

### 3. Compression Set

A specimen having a height of 12.5 mm was maintained compressed by 25% for 22 hours at a temperature of 120° C. in accordance with ASTM D-395, thereby measuring a compression set.

The compression set (as noted above) is an evaluation of assessing the extent to which a material (e.g., a rubber or polymer) is restored from a state compressed by external pressure over time, and is an important item in understanding the physical properties of a rubber material.

More specifically, as a metric used herein, compression set=height of initial specimen-height of specimen after compression/height of initial specimen×100.

### Example 1

An EPDM polymerization reaction was performed by a batch polymerization reaction. The solvent used in the polymerization reaction, ethylene, propylene, and 5-ethylidene-2-norbornene (ENB) were purified by column purification before use. In a 3 L reactor, an inert reactor environment was created using flushing using a solvent and purified nitrogen at a high temperature. 851 g of hexane was added to the reactor, 0.69 g of ethylaluminum sesquichloride (EASC), 42000 cc of propylene, 15000 cc of ethylene, and 3 g of 5-ethylidene-2-norbornene (ENB) were added thereto, and the temperature of the reactor was maintained at 30° C. while stirring at 250 rpm. 0.115 g of VOCl₃ and normal butylamine were previously mixed at the content listed in the following Table 1, and the mixture was added to the reactor in advance, thereby performing the EPDM polymerization reaction. The polymerization reaction started at 30° C., and was performed for 10 minutes after heating to 40° C. The physical properties of the prepared polymer were evaluated, and are shown in Table 1.

### Examples 2 and 3

An EPDM polymerization reaction was performed in the same manner as in Example 1, except that the content of normal butylamine was changed as shown in Table 1. The physical properties of the prepared polymer were evaluated, and are shown in Table 1.

### Examples 4 to 6

An EPDM polymerization reaction was performed in the same manner as in Example 1, except that normal butylamine and VOCl₃ were sequentially added as follows, without previously mixing them.

That is, hexane was added to the reactor, ethylaluminum sesquichloride (EASC), normal butylamine, propylene, ethylene, and 5-ethylidene-2-norbornene (ENB) were added at the contents listed in the following Table 1, and the temperature of the reactor was maintained at 30° C. while stirring at 250 rpm. VOCl₃ was added to the reactor at the content listed in Table 1, thereby performing the EPDM polymerization reaction. The polymerization reaction started at 30° C., and was performed for 10 minutes after heating to 40° C. The physical properties of the prepared polymer were evaluated, and are shown in Table 1.

### Examples 7 to 11

An EPDM polymerization reaction was performed in the same manner as in Example 1, except that the type of catalyst modifier was changed to the type listed in Table 1, instead of normal butylamine. The physical properties of the prepared polymer were evaluated, and are shown in Table 1.

### Example 12

An EPDM polymerization reaction was performed in a continuous polymerization reaction. The solvent used in the polymerization reaction, ethylene, propylene, and 5-ethylidene-2-norbornene (ENB) were purified by column purification before use. Polymerization was performed by using hexane as the solvent, continuously adding 1370 kg/hr of ethylene, 1500 kg/hr of propylene, and 140 kg/hr of 5-ethylidene-2-norbornene (ENB), and continuously adding 1.8 kg/hr of VOCl₃, 10.8 kg/hr of ethylaluminum sesquichloride (EASC), and 0.6 kg/hr of n-butylamine. A polymerization temperature was maintained at 40° C. Normal butylamine was added simultaneously with VOCl₃, but added separately through separate inlets. The prepared polymer was manufactured into an EPDM bale through a flashing process, a catalyst removal process, a solvent removal process, a drying process, and a baling process, and the physical properties of the manufactured product were evaluated and are shown in Table 1.

### Comparative Example 1

An EPDM polymerization reaction was performed in the same manner as in Example 1, except that normal butylamine was not used as shown in Table 1. The physical properties of the prepared polymer were evaluated, and are shown in Table 1.

### Comparative Examples 2 to 3

An EPDM polymerization reaction was performed in the same manner as in Example 1, except that heptylamine or ammonia was used as shown in Table 1, instead of normal butylamine. Gaseous ammonia was added using a mass flow controller. The physical properties of the prepared polymer were evaluated, and are shown in Table 1.

### Comparative Example 4

An EPDM polymerization reaction was performed in the same manner as in Example 12, except that normal butylamine was not used. The physical properties of the prepared polymer were evaluated, and are shown in Table 1.

TABLE 1

| | | Catalyst | | | | | | | |
|---|---|---|---|---|---|---|---|---|---|
| | | modifier/ | | | | | | | |
| | | V | | | | | | | Residual |
| | | (Mole | C2 | ENB | Mw | Mz | | Yield | vanadium, |
| | Addition method | ratio) | (wt %) | (wt %) | g/mol | g/mol | MWD | (g) | ppm |
| Comparative | — | 0 | 61.6 | 9.3 | 336,641 | 1,076,465 | 4.33 | 28.4 | 7 |
| Example 1 | | | | | | | | | |
| Example 1 | Premixing | 0.25 | 59.0 | 8.5 | 252,198 | 556,137 | 3.26 | 27.3 | 8 |
| Example 2 | Premixing | 0.5 | 53.8 | 8.0 | 264,139 | 610,993 | 2.86 | 27.1 | 9 |
| Example 3 | Premixing | 1 | 59.0 | 8.5 | 235,511 | 480,095 | 2.54 | 25.5 | 13 |
| Example 4 | Separate | 0.25 | 58.9 | 8.5 | 255,850 | 699,544 | 3.50 | 28.1 | 8 |
| | addition | | | | | | | | |
| Example 5 | Separate | 0.5 | 58.2 | 8.4 | 242,221 | 530,513 | 2.79 | 27.5 | 9 |
| | addition | | | | | | | | |
| Example 6 | Separate | 1 | 57.5 | 8.4 | 234,626 | 492,999 | 2.64 | 26.1 | 20 |
| | addition | | | | | | | | |
| Example 7 | Premixing (t- | 1 | 59 | 8.8 | 270,000 | 550,000 | 2.6 | 18.3 | 20 |
| | butylamine) | | | | | | | | |
| Example 8 | Premixing (t- | 0.5 | 58.5 | 8.6 | 252,445 | 576,133 | 2.90 | 27.6 | 10 |
| | butylamine) | | | | | | | | |
| Example 9 | Premixing | 0.5 | 59.7 | 8.7 | 252,198 | 556,137 | 2.89 | 27.1 | 13 |
| | (Pentylamine) | | | | | | | | |
| Example 10 | Premixing | 0.5 | 59.8 | 8.2 | 255,593 | 567,183 | 2.67 | 27.4 | 17 |
| | (Hexylamine) | | | | | | | | |
| Example 11 | Premixing (Di- | 0.5 | 59.0 | 8.5 | 252,198 | 586,111 | 2.58 | 27.8 | 20 |
| | butylamine) | | | | | | | | |
| Example 12 | Separate | 0.75 | 62.8 | 4.7 | 388,866 | 805,232 | 2.49 | — | 6.4 |
| | addition | | | | | | | | |
| Comparative | Premixing | 0.5 | 59 | 8.7 | 276,250 | 670,967 | 3.12 | 27.2 | 44 |
| Example 2 | (heptylamine) | | | | | | | | |
| Comparative | Ammonia | 0.5 | 60.1 | 8.6 | 320,000 | 880,000 | 3.74 | 28.3 | 7 |
| Example 3 | | | | | | | | | |
| Comparative | — | 0 | 60.9 | 4.8 | 374,963 | 854,837 | 4.1 | — | 1.5 |
| Example 4 | | | | | | | | | |

As shown in Table 1, in Examples 1 to 12, when the mole ratio of the amine compound used as the catalyst modifier to the content of vanadium (V) of the VOCl₃ catalyst increased, the molecular weight distribution was further decreased. In addition, the molecular weight distribution was further lowered in a range of the amine compound mole ratio of 0.5 to 1, and specifically, the physical properties of the molecular weight distribution of 2 to 3 and a residual vanadium content of 20 ppm or less were satisfied.

In addition, as seen in FIGS. 1 and 2, as compared with Comparative Example 1 in which normal butylamine was not used as the catalyst modifier, in Examples 1 to 6, the molecular weight distribution was further lowered and the ultra-high molecular weight content was further decreased. Specifically, as seen in FIGS. 1 and 2, when log (M) was 6 in a differential molecular weight distribution curve in which the horizontal axis was a logarithmic value of molecular weight M, log (M), and the vertical axis was dw/dlog (M) obtained by differentiating a concentration fraction w by the logarithmic value of molecular weight, log (M), the dw/dlog (M) value was relatively lower in Examples 1 to 6 than in Comparative Example 1, from which it was confirmed that the ultra-high molecular weight content was lower. In addition, the maximum peak was shown at a dw/dlog (M) value ranging from 5≤log (M)≤6, and dw/dlog (M) was larger in Examples 1 to 6 than Comparative Example 1.

In addition, as compared with Example 12 prepared by a continuous polymerization reaction with Comparative Example 4, the molecular weight distribution was lower in Example 12 using normal butylamine as the catalyst modifier, and the ultra-high molecular weight content was further decreased.

In addition, as compared with Comparative Example 2 using heptylamine and Examples 2, 5, and 8 to 11 using C4-C6 alkyl amine at the same content, the ultra-high molecular weight suppression effect was expressed also in Comparative Example 2, but the effect was small as compared with other examples. Since the removal efficiency of the polymerization catalyst was decreased, the residual vanadium catalyst content in polymerized EPDM was greatly increased. When the residual catalyst content is increased, in the case of preparing a compound composition, a degree of yellowish discoloration of a product may be increased.

In addition, as seen in Comparative Example 3, when ammonia was used, bp was low and a hexane solubility was low, and thus, ammonia was separated as a gas phase in the upper stage of the reactor and hardly existed in the liquid layer in the lower stage of the reactor where EPDM was polymerized, and thus, the participation efficiency in the ultra-high molecular weight production suppression reaction was low.

### EXPERIMENTAL EXAMPLES

Example 12 and Comparative Example 4 (which showed similar weight average molecular weights) were used to prepare a compound composition and a compression set was evaluated.

The compound composition was evaluated according to a compression set evaluation method after mixing 80 parts by weight of carbon black (N550) with respect to 100 parts by weight of EPDM in a Banbury mixer, and further mixing 5 parts by weight of ZnO, 0.5 parts by weight of 2-mercaptobenzothiazole (MBT), 1.0 part by weight of tetramethyl thiuram disulfide (TMTD), 1.5 parts by weight of sulfur in a roll mill mixer.

As a result, the compression set of the compound composition using Example 12 was 45.3%, and the compression set of the compound composition using Comparative Example 4 in which the catalyst modifier of the present disclosure was not used was 52%. Accordingly, when the EPDM copolymer prepared by the preparation method of the present disclosure was used, the compression set of the compound composition was lower, and the compound composition may be applied to an automotive weather strip.

TABLE 2

| | Type of EPDM | Compression set(%) | Color of EPDM |
|---|---|---|---|
| Experimental | Comparative | 52.0 | White |
| Example 1 | Example 4 | | |
| Experimental | Example 12 | 45.3 | White |
| Example 2 | | | |

The method of preparing an EPDM copolymer according to one embodiment of the present disclosure suppresses a reaction of making an EPDM polymer having an ultra-high molecular weight during solution polymerization using a Ziegler-Natta catalyst system and provides an EPDM copolymer having a narrow molecular weight distribution.

The EPDM copolymer prepared according to another embodiment of the present disclosure has a narrow molecular weight distribution, and production of an ultra-high molecular weight tail on GPC may be suppressed to provide an EPDM copolymer having a decreased peak of an ultra-high molecular weight tail on the GPC.

In addition, the compound composition using the EPDM copolymer prepared according to one embodiment of the present disclosure has an effect of lowering a compression set.

In addition, the EPDM copolymer prepared according to another embodiment of the present disclosure and the compound composition using the same may be applied to the field requiring a low compression set at room temperature and a high temperature, such as automotive weather strip and seal.

Hereinabove, although the present invention has been described by specified matters and specific exemplary embodiments, they have been provided only for assisting in the entire understanding of the present invention. Therefore, the present invention is not by the specific matters limited to the embodiments described herein. Various modifications and changes may be made based on this description.

Therefore, the present invention should not be limited to the above-described embodiments, and all modifications equal or equivalent to the described embodiments fall within the scope of the invention.

What is claimed is:

1. A method of preparing an ethylene propylene diene (EPDM) copolymer by solution polymerization using a Ziegler-Natta catalyst system,
wherein the Ziegler-Natta catalyst system includes VOCl₃, ethylaluminum sesquichloride (EASC), and a straight chain or branched chain C4-C6 alkyl amine as a catalyst modifier, and the method includes:
performing polymerization by adding the catalyst modifier before injecting VOCl₃ or by adding VOCl₃ and the catalyst modifier simultaneously.

2. The method of preparing an EPDM copolymer of claim 1, wherein the EPDM copolymer has a molecular weight distribution of Mw/Mn, where Mw is a weight average molecular weight and Mn is a number average molecular weight, of 5 or less and a residual vanadium content of 20 ppm or less.

3. The method of preparing an EPDM copolymer of claim 2, wherein the molecular weight distribution ranges from 2 to 3.

4. The method of preparing an EPDM copolymer of claim 1, wherein the EPDM copolymer has a weight average molecular weight ranging from 200,000 to 400,000 g/mol.

5. The method of preparing an EPDM copolymer of claim 1, wherein a content of the catalyst modifier is at a mole ratio ranging from 0.25 to 1 with respect to 1 mol of VOCl₃.

6. The method of preparing an EPDM copolymer of claim 1, wherein a content of the catalyst modifier is at a mole ratio ranging from 0.5 to 1 with respect to 1 mol of VOCl₃.

7. The method of preparing an EPDM copolymer of claim 1, wherein the catalyst modifier is n-butylamine.

8. The method of preparing an EPDM copolymer of claim 1, wherein the method is performed by a batch polymerization method or a continuous polymerization method.

9. The method of preparing an EPDM copolymer of claim 1, wherein a solvent used in a reaction during the solution polymerization is a hydrocarbon-based solvent.

10. The method of preparing an EPDM copolymer of claim 9, wherein the hydrocarbon-based solvent is any one or a mixture of two or more selected from the group consisting of pentane, hexane, heptane, and octane.

11. The method of preparing an EPDM copolymer of claim 1, wherein the polymerization is performed at 30 to 50° C.

12. The method of preparing an EPDM copolymer of claim 1, wherein in the polymerization, a content ratio of propylene, ethylene, and 5-ethylidene-2-norbornene (ENB) ranges from 20 to 40 wt % of propylene, 50 to 70 wt % of ethylene, and 5 to 10 wt % of the ENB.

13. An ethylene propylene diene (EPDM) copolymer prepared by the method of claim 1.

14. A compound composition comprising the EPDM copolymer prepared by the method of claim 1.

15. The compound composition of claim 14, wherein the compound composition has a compression set of 50% or less, when the composition is maintained compressed by 25% for 22 hours at a temperature of 120° C. in accordance with ASTM D-395.

16. A polymer comprising:
propylene,
ethylene, and
5-ethylidene-2-norbornene (ENB),
wherein a content ratio of the propylene, the ethylene, and the ENB ranges from 20 to 40 wt % of the propylene, 50 to 70 wt % of the ethylene, and 5 to 10 wt % of the ENB.

17. The polymer of claim 16, having a molecular weight distribution of Mw/Mn, where Mw is weight average molecular weight and Mn is the number average molecular weight, ranges from 2 to 5.

18. The polymer of claim 16, having a residual vanadium content ranging from 1 to 30 ppm.

19. The polymer of claim 16, having a weight average molecular weight ranging from 200,000 to 400,000 g/mol.

20. The polymer of claim 16, having a compression set of ranging from 40 to 50% in accordance with ASTM D-395.
